(19) United States
(12) Patent Application Publication
(10) Pub. No.: US 2014/0215707 A1
(43) Pub. Date: Aug. 7, 2014

(54) WATER BASIN WITH ILLUMINATED EDGE STONES

(71) Applicant: Hans-Robert Blum, Haibach (DE)

(72) Inventor: Hans-Robert Blum, Haibach (DE)

(21) Appl. No.: 14/234,592

(22) PCT Filed: Jun. 26, 2012
(86) PCT No.: PCT/DE2012/000645

§ 371 Date: Apr. 7, 2014

(30) Foreign Application Priority Data
Jul. 26, 2011 (DE) 10 2011 108 518.5
Apr. 20, 2012 (DE) 10 2012 007 999.0

(51) Int. Cl. E04H 4/14; F21V 33/00

(52) U.S. Cl. CPC E04H 4/148; F21V 33/006; F21W 2131/401
USPC 4/506; 362/152

(57) ABSTRACT

A water basin, such as, for example, a swimming pool, consisting of a lank which can be filled with water and edge stones arranged in a row against one another at the edge of the tank and of an illumination which extends in the region of the edge, wherein at least one of the edge stones consists at least partially of transparent or translucent material and has arranged in its interior at least one light source of which the light rays can exit through the transparent or translucent regions of the edge stone.

The invention relates to a water basin such as for example a swimming pool, consisting of a tank which can be filled with water and edge stones arranged in a row against one another at the edge of the tank and of an illumination which extends in the region of the edge.

For water basins such as for example swimming pools in gardens, in parks, in public swimming pools, on cruisers or in other places, an illumination is necessary at dusk and in the darkness when e.g. a swimming pool is to be used at these times of the day as well. Moreover, an illumination is also a means of design, e.g. for optically highlighting a water basin in the darkness and emphasising its shape by illuminating its edge area.

The state-of-the-art utility model DE 20 201 0 003 733 describes a “wall edging strip” which must be set into the lateral wall of a swimming pool. The strip contains a groove into which a strip-type light source such as an LED strip can be inserted.

A disadvantage is that the brickwork of the tank of the swimming pool must be adapted to the profile of the wall edging strip using suitable special blocks or a structure of numerous, very small stones or by chiselling out or cutting in an appropriate slot.

A further disadvantage is that either the light source itself must be resistant to water and ozone or chlorine or other sterilization or cleaning agents contained therein or that a disc must be fitted into the opening of the groove of the wall edging strip so as to produce a permanent seal. Such adaptations require numerous hours of work to be performed manually and come with the risk of variations in quality—in particular as concerns their sealing properties.

In light of the above, the object of the invention is to develop, for the illumination of the edge region of a swimming pool or other water basin, elements which can be integrated into the edge of a swimming pool with little adaptation work needed and at the same time can be sealed quickly and easily. At one stage of completion, the electric connection shall also be made, substantially as part of the same operation.

To achieve the object, the invention teaches that at least one of the edge stones is made at least partially of a transparent or translucent material and inside it there is arranged at least one light source, the light rays of which exit through the transparent or translucent areas of the edge stone.

The invention is based on the fact that a water basin is generally distinguished from a pond or a bath tub by edge stones which are arranged at the edge of the tank that holds the water. Such edge stones serve to mechanically stabilize the edges of the water basin. They prevent excessive amounts of water from leaking out the water basin and into the surrounding soil. At the same time, they are a mechanical stabilization of that zone which frequently must be scaled to allow persons to linger in that edge region and even jump into the water from there.

As any lighting fixtures installed in that region may either be exposed to considerable mechanical loads or must also be resistant to water and any sterilization or cleaning agents that may be contained therein, the underlying concept of the invention is to remove the lighting fixtures from such influences by arranging them inside the edge stones, where they are protected against both the loads caused by persons lingering there or jumping from there and against the influence of water and its constituents.

To allow the light rays to exit from inside the edge stones, they must consist at least partially of a transparent or translucent material. The light source must be arranged so as to allow its light rays to exit through these areas. If e.g. an edge stone in a very simple design is fitted with only one single light source which is to shine upward, that is, which is to be arranged as an “underfloor luminaire” according to the current use of language, it will be sufficient if the edge stone is a hollow body of concrete or ceramics into which a light source is placed and which is covered by a disc at the top, such disc being sufficiently mechanically resilient and sealed against water.

In another embodiment, the whole edge stone can consist of a transparent or translucent material inside which at least one light source is arranged. Therein, said single light source or at least one light source within the edge stone can shine both upward and to the side, that is, approximately parallel to the water surface.

When designing the whole water basin, the edge stones according to the invention enable full circumferential illumination of the edge. For this, in a particularly upscale version, each edge stone has at least one light source. This clearly highlights the contours of the water basin from a distance. Near the edge region, a safe use of the water basin will be enabled even in the absence of daylight.

In more cost-effective embodiments, only every second or every third edge stone or any other regular order of edge stones will each be fitted with at least one light source.

A further design parameter of the invention is the direction of the light rays. They can illuminate the water surface out of the narrow side of the edge stones. But they can also exit approximately upward. In this case they act as “underfloor luminaires” which, e.g. in case of a very narrow light exit angle, spotlight persons or highlight posts located at the edge decoratively from below.

In an interesting embodiment, the edge stones project beyond the edge of the tank, that is, are in part located above the water surface. In this design, light rays can also exit from the part of the exterior surface of the edge stone pointing to the water surface and throw their light on the water surface. An embodiment is conceivable in which light rays exit only in this direction towards the water surface. In other versions, the light rays can also shine on the water surface in addition to other light sources.

In another embodiment, at least one edge stone can protrude beyond the edge of the tank, that is, stands in part above the water surface. In this case it is possible that a groove is cut into such part of the exterior surface of the edge stone pointing to the water surface and a light source such as an LED strip is inserted therein. Of course, such LED strip must then be secured against water splashing or sloping up, e.g. by embedding it into a waterproof medium or by sealing the groove to be outwardly waterproof. In this version, it is also possible to use a very long light source such as a light hose stretching across several edge stones.

In any event, however, an edge stone according to the invention comprises one light source. Such light source can be introduced into the edge stone according to two different principles. In a first version, the edge stone is a hollow body and all light sources are introduced into such hollow space. In a fundamentally different version, the edge stone is made of a solid material fully enclosing the light sources. If the edge stone is cast, e.g. of a liquid plastic, it is conceivable that the light sources are cast into this plastic block. Therein, of course, they must be able to withstand securely the melting temperature of such material.

Alternatively, the edge stone can e.g. also consist of two halves into which hollows are formed which are designed to complement the light sources. For installation, the light source is inserted into one of the two complementary “beds” and then the other half of the edge stone is glued thereon or otherwise firmly bonded therewith.

An object that must always be achieved is the electrical connection of each edge stone. In a very simple version, a “cable tail” which is to be electrically connected to a central energy source and possibly also to a central control protrudes from each of the edge stones.

In a more sophisticated embodiment, however, the electrical connection among the edge stones is already made while they are positioned. For this, each edge stone must have, at each first exterior surface pointing to an adjacent edge stone, an electrical plug which protrudes from this surface. On the second exterior surface pointing to the other adjacent edge stone, an electrical socket must be formed which is designed to complement the aforementioned electrical plug and which makes an electrical contact by connecting the socket with such plug. Within each edge stone, the electrical plug and the electrical socket and all light sources in the edge stone are then connected in parallel.

This allows the electrical wiring to be made—as it were, automatically—already as the edge stones are positioned by connecting each newly placed edge stone to the still free socket or the still free electrical plug.

Of course, each electrical connection contained therein requires suitable sealing to protect against the penetration of humidity. This is possible e.g. by a flexible seal which is compressed by pushing together two edge stones. Even a click-stop connection is conceivable which lets the fitter know that an appropriate sealing effect has been achieved by engaging with a noticeable click.

In practice, there will be cases of application where the light source or sources emit their light rays in a very narrow angel, such as, in an extreme case, the light fingers of a laser which is arranged inside an edge stone.

In many other cases of application, it may, however, be desired that the surface of the edge stones is illuminated as uniformly as possible. For this, e.g. electroluminescent films can be inserted into the transparent or translucent edge stones. Such films glow when an alternating voltage at a frequency between approximately 100 to 2000 Hertz is applied, while light emission is distributed over the surface with almost perfect uniformity. Therein, it should be noted that the luminous intensities that can be achieved are relatively low, the price of the film is relatively high and also, to provide electrical energy, an individual power supply unit is always required which delivers the frequency needed with sufficient power.

Therefore, according to the state of the art, different types of light bulbs—e.g. halogen lights for extending lifetime—are still suitable, as well as light-emitting diodes, also in the form of OLED, the abbreviation meaning organic light-emitting diode, based on layers of organic material.

All of these light sources generally emit their light at a more or less limited angle. To uniformly distribute these light rays at least on a part of the exterior surface of an edge stone, the invention proposes to connect to each light source glass fibres or moulded parts of plexiglass which uniformly distribute the light rays of the light source at least on a part of the exterior surface of an edge stone by at least one-time reflection.

Such light conductors are known in a large number of varieties according to their principle of operation. They can be inserted between the light source and the interior wall of a hollow edge stone as an additional assembly. From there, they protrude up to the light source.

Another alternative to conducting light is a reflector such as a metal film which diverts part of the light rays by reflection. In particular, in light bulbs and other light sources which emit their light rays over a particularly great angle, this allows the use of e.g. light rays which would otherwise only illuminate the non-visible faces of an edge stone.

Alternatively or additionally, also light conductors—in a small form as prisms or lenses—can be formed onto the shell of an edge stone to ensure a uniform distribution of the light rays there.

In another version, the exterior surface of at least one edge stone is coated with a varnish which contains metal elements with a bright and reflecting surface. Such metal elements serve a double purpose: on the one hand, to increase slip resistance and, on the other hand, to create reflections which are available as a further parameter in an aesthetic design.

Another embodiment is the coating with phosphorescent material. It contains elementary white phosphorus which can emit an afterglow after irradiation with ultraviolet light, also referred to as black light.

When coating with a fluorescent material, the choice of the fluorescent material enables a variety of different colours, which can be activated by irradiation with ultraviolet right rays that are common and identical for all part surfaces.

An edge stone according to the invention can also be a hollow body of glass, which has at least one opening through which the light sources can be inserted into the hollow space. Glass has the advantage that its raw materials are available in very large quantities and can be processed at low cost. Archaeology proves that the lifetime of glass parts can extend over centuries. As glass blocks they are known, tried and tested in buildings.

To be able to insert light sources into hollow bodies of glass, the latter must have appropriate openings. It is recommended to properly seal the openings after insertion so as to provide optimum protection for the light sources located in the hollow body.

For this purpose, the invention suggests circular openings provided with a thread. Closing lids with a complementary form can be screwed therein, and a sealant can be poured into the gap between the female and the male thread. Or a projecting lid pushes an o-ring seal on to the edge of the hollow body.

The electrical connection can be made through this closing lid. If the connection consists of two wires, the invention suggest coiling them in an opposing direction before they are screwed into the thread so that after the lid has been screwed in they are again untangled and are thus relatively detached from each other.

In a number of edge stones according to the invention, an optical design feature may be that the brightness and/or colour of the light sources can be changed individually or in groups by means of a central control. Or the whole illumination of the basin edge can be changed in its brightness or its colour or colours.

Alternatively, a “chaser light” which consists of a number of light sources that are switched on and off abruptly can move around the basin edge. Alternatively, the “wandering” light impulses can be generated by stepped or even infinite dimming of the individual light sources, provided the dimmer responds quickly enough.

An additional parameter is the respective colour of the light sources. So, e.g. multicoloured light-emitting diodes, which are formed by embedding light-emitting diodes of different colours in a single housing, are known.

To control these or other plays of light, each light source or each group of light sources can either be connected to the control by means of its own connecting cable, or a receiving or control module can be assigned to each light source or each group of light sources. Such module receives commands from the control which are transferred by way of a separate bus system. Alternatively, they can be transferred by impulses which are modulated upon the supply voltage. It is even conceivable to emit such control commands wirelessly by way of electromagnetic waves from a central control. The advantage is that then no extra information connection must be created as a physical line. In any event, the commands communicated by the control to the respective module are implemented for controlling the light sources or groups of light sources.

For water basins, in particular for swimming pools, it is useful that, at the edge of the water surface, at least in some of the edge stones, a channel is formed into their surface, which receives adjoins the channel of at least one adjacent edge stone. Such channels receive water sloping over. The overall channel formed from all channels in the individual edge stones can be connected to a connecting pipe or to a connecting channel. In this way, e.g. the water sloping over can be piped into a collecting basin and from there, or even directly, piped into a filtering or purification system.

In water basins with any desired contours, e.g. curved several times in changing directions, it is possible that the row of edge stones may only consist of specimens that differ from each other. In practice, however, the majority of the cases of application will be likely to be restricted to using a construction kit with a limited number of different types of edge stones.

In the edge stones of these construction kits, the profile in the direction of the edge is identical or can at least be combined with the adjacent edge stone. The length in the direction of the edge differs, e.g. edge stones having the full or half or a quarter of the standard length, and a very short correction piece.

The horizontal contour of the edge stones can be approximately rectangular—to form straight lines. A trapezoid contour is well suited for polygonal courses of the edge. Curves in the course of the edge can be put together by annulus segments.

In the following, other details and features of the invention will be explained with greater precision and including an example. However, it is not intended to limit, but only to explain the invention by a schematic illustration in which:

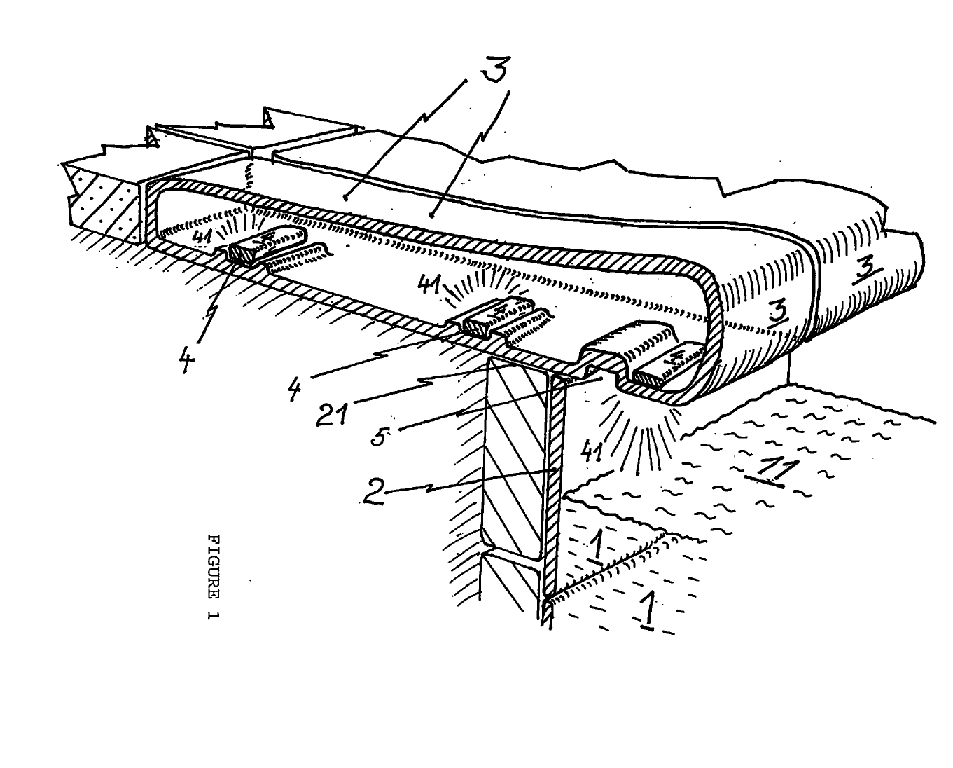

FIG. 1 shows a section through a water basin with an illuminated edge stone according to the invention

FIG. 1 shows a section through a tank (2) which is filled with water (1) and on the edge (21) of which an edge stone (3) according to the invention is placed. The edge stone (3) is made of a translucent or transparent material which is apparent from FIG. 1 by the fact that the rear edge between the vertical lateral walls is visible even through the curved surface.

FIG. 1 shows the edge stone (3) according to the invention in an embodiment as a hollow body which can be seen from the cut walls. A total of three light sources (4) can be seen on the bottom of the hollow body. Of these light sources (4), the central one and the left one radiate upward and the right one radiates downward.

In FIG. 1, the light rays (41) of the left and the central light source (4) radiate outward through the top cover surface of the edge stone (3). The light rays (41) of the right-sided light source (4) radiate downward through the projecting part of the edge stone (3) onto the water surface located below (11). FIG. 1 does not show, but it is easily comprehensible that, as a result, the light rays (41) can be refracted or reflected on the water surface (11) which provides a further parameter for the aesthetic design of the basin edge.

In the present embodiment, the two left light sources (4) are each secured by an adjacent bead in the base surface of the basin edge stone.

As a further embodiment, another groove (5) is shown in the projecting part of the basin edge stone (4). A light source (4)—not shown in FIG. 1—can be inserted into this groove (5) from below. From there, it then radiates—just as the light source (4) shown on the right hand side of the groove (5)—downward onto the water surface (11).

FIG. 1 does not show the electrical connections of the light sources (4). Nor does it show the possible plug connection between adjacent edge stones (3) with the option of connecting a projecting plug on the one joint face of an edge stone (3) with a complementary socket on the adjacent front face of the next edge stone (3).

### LIST OF REFERENCE NUMERALS

1 Water, can be filled in tank 2
11 Water surface
2 Tank
21 Edge of the tank 2
3 Edge stone at the edge 21 of the tank 2
4 Light source within an edge stone 3
41 Light rays of the light source 4

1. An edge stone in the form of a hollow body for a swimming pool or water basin, at least partially consisting of a transparent or translucent material, wherein a light source is arranged inside the edge stone, the light rays of which exit through the transparent or translucent areas of the edge stone.

2. An edge stone according to claim 1, wherein the whole edge stone consists of a transparent or translucent material, inside which at least one light source is arranged.

3. An edge stone according to claim 1, wherein at least one light source is arranged in the edge stone such that the at least one light source shines both upward and to the side, that is, approximately parallel to the water surface.

4. An edge stone according to claim 1, wherein the edge stones are configured and adapted to illuminated the water surface out of the narrow side of the edge stones and/or to shine upward.

5. An edge stone according to claim 1, wherein the edge stone, having been set in the ground, is configured and adapted to protrude at least partially beyond the edge of a tank of a water basin.

6. An edge stone according to claim 5, wherein light rays exit from the part of the exterior surface of the edge stone pointing to the water surface of the tank and throw their light on the water surface, wherein in particular the light rays exit exclusively in the direction to the water surface and/or radiate onto the water surface.

7. An edge stone according to claim 1, wherein the edge stone, having been set in the ground, is configured and adapted to protrude beyond the edge of a tank of a water basin so that it stands in part above the water surface, wherein a groove is cut into such part of the surface of the edge stone and a light source, in particular an LED strip, is inserted therein.

8. An edge stone according to claim 1, wherein the edge stone consists of two halves into which hollow spaces are formed which are designed to complement the light sources.

9. An edge stone according to claim 1, wherein the at least one light source is a laser, an electroluminescent film, a light bulb, a light-emitting diode and/or an OLED.

10. An edge stone according to claim 1, wherein at least one light source is adjoined by light conductors such as glass fibres or moulded parts of plexiglass which regularly distribute the light rays of the light source at least on a part of the exterior surface of an edge stone by at least one-time reflection.

11. An edge stone according to claim 1, wherein at least one edge stones contains at least one reflector such as a metal film which diverts part of the light rays by reflection.

12. An edge stone according to claim 1, wherein prisms or lenses which ensure a uniform distribution of the light rays are formed into the exterior surface of at least one edge stone.

13. An edge stone according to claim 1, wherein the exterior surface of at least one edge stone is coated with a varnish which comprises metal elements which can have a bright and reflecting surface.

14. An edge stone according to claim 1, wherein the exterior surface of at least one edge stone is coated with a phosphorescent and/or fluorescent paint.

15. An edge stone according to claim 1, wherein the edge stones are hollow bodies of glass which have at least one opening through which the light sources can be inserted into the hollow space.

16. An edge stone according to claim 15, wherein the openings are circular and provided with a thread into which a closing lid can be screwed, wherein the electrical connection can be integrated into a lid.

17. An arrangement of edge stones arranged next to one another for a swimming pool or water basin, wherein at least one of the edge stones is an edge stone according to claim 1.

18. An arrangement according to claim 17, wherein
the edge stones each have a projecting electrical plug on the first exterior surface pointing to an adjacent edge stone; and
an electrical socket is formed into the second exterior surface pointing to the other adjacent edge stone,
which is designed to complement the electrical plugs; and
which can be electrically connected thereto; and
within each edge stone
the electrical plug and
the electrical socket and
the light sources
are electrically connected in parallel; and
in at least one edge stone, a connection to an electrical source can be connected in parallel as well.

19. An arrangement according to claim 17, wherein
the brightness and/or the colour of the light sources can be changed individually or in groups by means of a central control.

20. An arrangement according to claim 17, wherein the row of edge stones consists of a low number of different types, identical to each other,
the profiles of which are identical in the direction of the edge or can at least be combined with the adjacent edge stone; and
the length of which differs in the direction of the edge; and
the horizontal contour of which can be approximately rectangular to form straight lines or is formed as a trapezium or as an annulus segment to form bends.

21. A water basin such as a swimming pool, consisting of
a tank which can be filled with water; and
edge stones arranged in a row against one another at the edge of the tank; and
an illumination which extends in the region of the edge, characterized in that
at least one of the edge stones is an edge stone according to claim 1.

22. A water basin according to claim 21, wherein
each, each second, each third, or any other regular order of edge stones is at least one edge stone according to claim 1.

23. A water basin according to claim 21, wherein the water basin comprises an arrangement of edge stones according to claim 36.

24. A water basin such as a swimming pool, consisting of
a tank which can be filled with water; and
edge stones arranged in a row against one another at the edge of the tank; and
an illumination which extends in the region of the edge,
wherein
at least one of the edge stones consists at least partially of a transparent or translucent material; and
inside it there is arranged at least one light source, the light rays of which exit through the transparent or translucent areas of the edge stone.

25. A water basin according to claim 24, wherein the edge is illuminated circumferentially,
by each edge stone having at least one light source; or
at least every second or every third edge stone or
any other regular order of edge stones having at least one light source.

26. A water basin according to claim 24, wherein the light rays exit from at least one edge stone approximately upward.

27. A water basin according to claim 24, wherein
the edge stones protrude beyond the edge of the tank and light rays exit exclusively or additionally from the part of the exterior surface of at least one edge stone pointing to the water surface.

28. A water basin according to claim 24, wherein
at least one edge stone protrudes beyond the edge of the tank and a groove is cut into the part of the exterior surface of the edge stone pointing to the water surface and a light source such as an LED strip is inserted therein.

29. A water basin according to claim 24, wherein
at least one edge stone is made of a solid material which fully encloses the light sources.

30. A water basin according to claim 24, wherein
the edge stones each have a projecting electrical plug on the first exterior surface pointing to an adjacent edge stone; and
an electrical socket is formed into the second exterior surface pointing to the other adjacent edge stone,
which is designed to complement the electrical plugs; and
which can be electrically connected thereto; and
within each edge stone
the electrical plug and
the electrical socket and
the light sources
are electrically connected in parallel; and
in at least one edge stone, a connection to an electrical source can be connected in parallel as well.

31. A water basin according to claim 24, wherein
at least one light source is adjoined by light conductors such as glass fibres or moulded parts of plexiglass which regularly distribute the light rays of the light source at least on a part of the exterior surface of an edge stone by at least one-time reflection.

32. A water basin according to claim 24, wherein
at least one edge stone comprises at least one reflector such as a metal film which diverts part of the light rays by reflection.

33. A water basin according to claim 24, wherein
prisms or lenses which ensure a uniform distribution of the light rays are formed into the exterior surface of at least one edge stone.

34. A water basin according to claim 24, wherein
the exterior surface of at least one edge stone is coated with a varnish which comprises metal elements which can have a bright and reflecting surface.

35. A water basin according to claim 22, wherein
the exterior surface of at least one edge stone is coated with a phosphorescent and/or fluorescent paint.

36. A water basin according to claim 24, wherein
the edge stones are hollow bodies of glass which have at least one opening through which the light sources can be inserted into the hollow space.

37. A water basin according to claim 36, wherein
the openings are circular and provided with a thread into which a closing lid can be screwed, wherein the electrical connection can be integrated into a lid.

38. A water basin according to claim 24, wherein
the brightness and/or the colour of the light sources can be changed individually or in groups by means of a central control.

39. A water basin according to claim 38, wherein
each light source or each group of light sources is connected to the control by way of its own connecting cable; or
a receiving or control module is assigned to each light source or each group of light sources and can receive commands from the control,
which are transferred by way of a bus system or by means of impulses modulated upon the supply voltage; and
which are implemented by the respective module in controlling the light source or the group of light sources.

40. A water basin according to claim 24, wherein
a channel is formed into the surface of at least some of the edge stones, which adjoins the channel of at least one adjacent edge stone and the overall channel formed from all channels in the individual edge stones can be connected to a connecting pipe or a connecting channel which leads away from the edge.

41. A water basin according to claim 24, wherein the row of edge stones consists of a low number of different types, identical to each other,
the profiles of which are identical in the direction of the edge or can at least be combined with the adjacent edge stone; and
the length of which differs in the direction of the edge; and
the horizontal contour of which can be approximately rectangular to form straight lines or is formed as a trapezium or annulus segment to form bends.
